(19) United States
(12) Patent Application Publication
(10) Pub. No.: US 2026/0012116 A1
(43) Pub. Date: Jan. 8, 2026

(54) POWER SEMICONDUCTOR CIRCUIT FOR MOTOR DRIVING

(71) Applicant: XIANGFEI MENG, NANJING (CN)

(72) Inventor: XIANGFEI MENG, NANJING (CN)

(21) Appl. No.: 19/254,243

(22) Filed: Jun. 30, 2025

(30) Foreign Application Priority Data
Jul. 2, 2024 (CN) 2024108809802

(51) Int. Cl. H02P 27/06

(52) U.S. Cl. CPC H02P 27/06

(57) ABSTRACT

A multi-phase full-bridge drive system for motor driving, including: a multi-phase full-bridge circuit including at least three half-bridge circuits which are identical, wherein each of the half-bridge circuits includes a first transistor and a second transistor, wherein the short-circuit withstand capability of the first transistor is stronger than that of the second transistor and the short-circuit saturation current of the first transistor is lower than that of the second transistor, and wherein each of the half-bridge circuits further includes a first and a second transistor driving part, which are connected to the control terminals of the first transistor and the second transistor, respectively, to control the first transistor and the second transistor; and a controller connected to the first and the second transistor driving part of each of the half-bridge circuits, respectively, to control the multi-phase full-bridge circuit to generate a target multi-phase driving voltage for driving the motor.

### CROSS REFERENCE TO RELATED APPLICATION

This application claims the benefit of priority to Chinese Application No. 2024108809802, filed on Jul. 2, 2024, which is herein incorporated by reference.

### FIELD

The present disclosure relates to the field of power semiconductors and motor driving, and particularly, a power semiconductor circuit for motor driving.

### BACKGROUND

In the field of motor driving, a three-phase full-bridge circuit configured by power semiconductors is needed to convert a direct current (DC) and an alternating current (AC) with each other. The so-called three-phase full-bridge circuit comprises three half-bridge circuits, and the so-called half-bridge circuit is usually realized by switching elements configured by power semiconductors. Flow and transformation of current are realized through the turn on and turn off control of the switching elements.

At present, main power semiconductor transistors commonly used in the field of motor driving include an IGBT, a silicon carbide MOSFET, a silicon carbide JFET, a gallium nitride HEMT and so on. At present, the silicon carbide MOSFET is widely used in the field of motor driving because of its high efficiency. However, due to its own characteristics, short-circuit withstand capability of the silicon carbide MOSFET is weak, which leads to poor reliability of a driving system using the silicon carbide MOSFET. Similarly, the gallium nitride HEMT has weaker short-circuit withstand capability, and it is easy to explode in the case of short-circuit, causing damage to a driving system, which makes it face a big bottleneck in the application of motor driving.

### SUMMARY

In view of the above, the present disclosure discloses power semiconductor circuits for motor driving. The power semiconductor circuits may be embodied in the form of half-bridge circuits, multiphase full-bridge circuits including multiple half-bridge circuits and so on. These power semiconductor circuits disclosed in the disclosure comprises half-bridge circuit(s) configured by hybrid devices combining a power semiconductor transistor with weak short-circuit withstand capability and a power semiconductor transistor with strong short-circuit withstand capability. When a phase-to-phase short circuit or a bridge arm short circuit occurs, a device with strong short-circuit withstand capability in each half-bridge circuit may turn off the short-circuit current reliably to avoid the damage to the switching device/semiconductor transistor with weak short-circuit withstand capability, thus improving the reliability of the whole drive system. In this field, the short-circuit withstand capability, sometimes simply referred to as the short-circuit capability, refers to the ability of the transistor or switching element to reliably turn off the short circuit current in the event of a short circuit in the bridge arm or a short circuit between phases of the drive system. Generally, the short-circuit withstand capability is embodied in terms of a short circuit withstand time, wherein the short circuit withstand time refers to how long the transistor or switching element is able to withstand the short circuit without being damaged.

In one aspect, the present disclosure discloses a half-bridge circuit including a first switching element located on an upper bridge arm and a second switching element located on a lower bridge arm. The half-bridge circuit is configured by two switching elements located on the upper bridge arm and the lower bridge arm, which are realized by power semiconductors. The first switching element is configured by a power semiconductor transistor and a transistor driving part for the power semiconductor transistor. Optionally, the first switching element may connect with one power semiconductor diode in anti-parallel. The second switching element is configured by a power semiconductor transistor and its transistor driving part. The second switching element has stronger short-circuit withstand capability than the first switching element, and a saturation current of the second switching element when short-circuit occurs is lower than that of the first switching element. Optionally, the second switching element may be connected with a power semiconductor diode in anti-parallel.

The upper bridge arm of the above half-bridge circuit may be configured by a first switching element, and the lower bridge arm may be configured by a second switching element. Alternatively, the upper bridge arm may be configured by the second switching element and the lower bridge arm may be configured by the first switching element. The upper bridge arm is connected with a motor terminal and positive potential of a power bus, and the lower bridge arm is connected with the motor terminal and the negative potential of the power bus.

In another aspect, the present disclosure discloses a multiphase full-bridge driving system for motor driving, including a multiphase full-bridge circuit configured by at least three half-bridge circuits as described above, and a controller connected with the multiphase full-bridge circuit to control the multiphase full-bridge circuit, so as to output a target multiphase driving voltage.

In yet another aspect, the present disclosure discloses a three-phase full-bridge driving system for motor driving, which includes a three-phase full-bridge circuit configured by three half-bridge circuits as described above.

Generally, in the field of motor driving, a motor may be a synchronous motor or an asynchronous motor. The motor is generally a three-phase motor with at least three lead terminals. Each lead terminal is connected to one half-bridge circuit as mentioned above. In this way, three half-bridge circuits together form a three-phase full-bridge circuit.

### BRIEF DESCRIPTION OF THE DRAWINGS

Specific exemplary embodiments of the present disclosure will now be described with reference to the accompanying drawings. The features, aspects and advantages of the present disclosure will be apparent from reviewing the following detailed description together with the accompanying drawings. In the drawings:

FIG. 1 shows a schematic diagram of a three-phase full-bridge drive system for motor driving according to an embodiment of the present disclosure; and

FIG. 2 shows a schematic diagram of a three-phase full-bridge drive system for motor driving according to another embodiment of the present disclosure

### DETAILED DESCRIPTION

Some implementations of the present disclosure will now be described more fully hereinafter with reference to the accompanying drawings, in which some but not all implementations of the present disclosure are shown. In fact, various implementations of the disclosure may be embodied in many different forms and should not be construed as limited to the implementations set forth herein. Instead, these exemplary implementations are provided to convey the scope of the disclosure to those skilled in the art better.

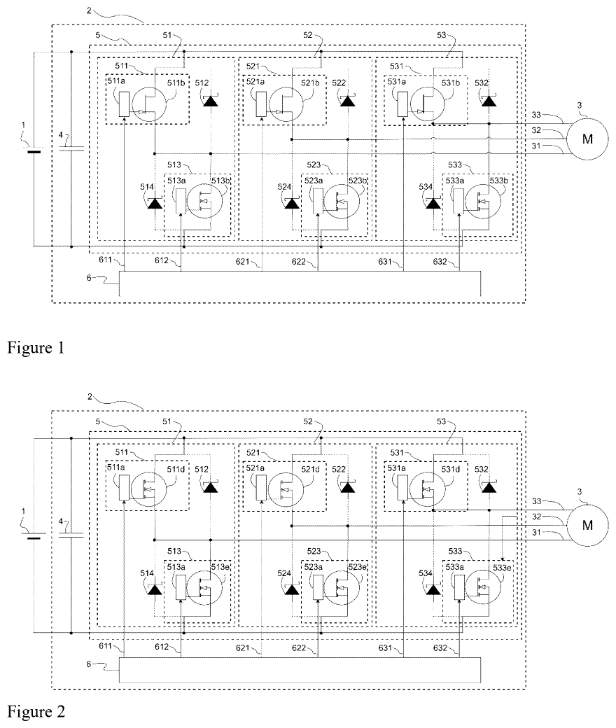

FIG. 1 shows a schematic diagram of a three-phase full-bridge drive system for motor driving according to an embodiment of the present disclosure. In FIG. 1, a DC power supply 1 supplies DC power to a three-phase full-bridge drive system 2. In one embodiment, the DC power supply 1 is a rechargeable battery. The three-phase full-bridge drive system 2 outputs a target three-phase drive voltage for driving a synchronous motor or an asynchronous motor 3. The three-phase full-bridge drive system 2 includes a three-phase full-bridge circuit 5 and a controller 6. In another embodiment, the three-phase full-bridge drive system 2 further includes a smoothing capacitor 4.

The three-phase full-bridge circuit 5 is a DC-AC conversion circuit, which may convert a DC voltage applied by the DC power supply 1 into three-phase AC voltage for controlling the motor 3, and may also convert three-phase AC voltage generated by the motor into DC voltage. The three-phase full-bridge circuit 5 is configured by three half-bridge circuits 51, 52 and 53. Each of the half-bridge circuits is connected with a respective one of three terminals 31, 32 and 33 of the motor 3.

The controller 6 is used to transmit control signals to transistor driving parts 511a, 521a, 531a, 513a, 523a, 533a of the three-phase full-bridge drive system 2 through signal terminals 611, 612, 621, 622, 631, 632, for controlling the three-phase full-bridge drive system 2. The controller 6 may be realized in the form of a programmable logic device, a processor, a microprocessor, etc. The transistor driving parts 511a, 521a, 531a, 513a, 523a and 533a are connected with control terminals of transistors of upper bridge arms and lower bridge arms of the half-bridge circuits respectively, to drive the corresponding transistors to be turned on or off. In one embodiment, each of the transistor driving parts may also configure the performance of the transistor connected therewith, for example configure its switching loss, short-circuit withstand capability, a short-circuit saturation current and the like.

The three half-bridge circuits 51, 52 and 53 are identical with each other. For the sake of clarity, only the half-bridge circuit 51 will be described in detail here. The half-bridge circuit 51 is configured by an upper bridge arm and a lower bridge arm. The upper bridge arm is connected with a positive potential of the DC power supply 1 and a motor terminal 31. The lower bridge arm is connected with a negative potential of the DC power supply 1 and the motor terminal 31. The upper bridge arm shown in FIG. 1 includes a switching element 511 and a power semiconductor diode 512 connected with the switching element 511 in anti-parallel. The switching element 511 includes a power semiconductor transistor 511b and a transistor driving part 511a connected to a control terminal (e.g., a gate) of the power semiconductor transistor 511b for driving or otherwise configuring the power semiconductor transistor 511b. The transistor driving part 511a receives a control signal 611 from the controller 6, thereby realizing the control of the upper bridge arm by the controller 6. The lower bridge arm includes a switching element 513 and a power semiconductor diode 514 connected in anti-parallel with the switching element 513. The switching element 513 includes a power semiconductor transistor 513b and a transistor driving part 513a connected to a control terminal of the power semiconductor transistor 513b for driving or otherwise configuring the power semiconductor transistor 513b. The transistor driving part 513a receives a control signal 612 from the controller 6, thereby realizing the control of the lower bridge arm by the controller 6. Short-circuit withstand capability of the switching element 513 of the lower bridge arm is weaker than that of the switching element 511 of the upper bridge arm, and a short-circuit saturation current of the switching element 513 of the lower bridge arm is greater than the switching element 511 of the upper bridge arm. It should be noted that the switching element shown in FIG. 1 is illustrated as including a transistor and a corresponding transistor driving part, which may be integrated with each other, or alternatively, may be realized as separate devices. In another embodiment, the transistor driving part may be integrated in the controller 6. No matter what form it takes, the transistor driving part is used to drive the transistor connected thereto to be turned on or off, or to configure the characteristics of the transistor connected thereto, such as adjusting a switching loss, short-circuit withstand capability and a short-circuit saturation current of the transistor.

In the embodiment shown in FIG. 1, the power semiconductor transistor 511b is configured by a silicon carbide JFET, and the power semiconductor diode 514 forming a commutation loop with the power semiconductor transistor 511b includes a silicon carbide diode with a Schottky structure or a fast recovery diode. The power semiconductor transistor 513b is configured by a silicon carbide MOSFET, and the power semiconductor diode 512 forming a commutation loop with the power semiconductor transistor 513b includes a silicon carbide diode with a Schottky structure. The silicon carbide diode includes a silicon carbide Schottky barrier diode (SBD), a silicon carbide Junction Barrier Schottky (JBS) diode and a Merged pin Schottky (MPS) diode. The fast recovery diode is generally silicon-based, which has good forward conduction performance and a lower cost than that of the silicon carbide diode with a Schottky structure. Therefore, if a diode is optionally provided in anti-parallel, providing the diode in the three-phase full-bridge drive system 2 as a fast recovery diode may facilitate the utilization of the good forward conduction performance of the fast recovery diode. Since the power semiconductor transistor 511b (i.e., the silicon carbide JEFT) has reverse recovery capability, the power semiconductor diode 512 may not be provided in the three-phase full-bridge drive system 2. If the power semiconductor diode 512 is not provided, the reverse recovery will occur on the power semiconductor transistor 511b, and thus, a reverse recovery loss on the power semiconductor transistor 511b will be greater when the power semiconductor transistor 513b is turned on. However, the cost of the whole three-phase full-bridge drive system may be reduced, because a group of diodes are omitted. Since the power semiconductor transistor 513b (that is, the silicon carbide MOSFET) has reverse recovery capability, the power semiconductor diode 514 may not be provided. If the power semiconductor diode 514 is not provided, the reverse recovery will occur on the power semiconductor transistor 513b, and thus, a reverse recovery loss on the power semiconductor transistor 513b will be larger when the power semiconductor transistor 511b is turned on. However, the cost of the whole three-phase full-bridge drive system may be reduced, because a group of diodes are omitted. The short-circuit withstand capability of the switching element 513 of the lower bridge arm is weaker than that of the switching element 511 of the upper bridge arm. That is, the short-circuit withstand capability of the switching element including the silicon carbide MOSFET is weaker than that of the switching element including the silicon carbide JEFT, while the short-circuit saturation current of the switching element including silicon carbide MOSFET is higher than that of the switching element including silicon carbide JFET.

The transistor driving part 511a may control the power semiconductor transistor 511b to be in an ON state, and thus the corresponding motor terminal 31 is connected with the positive potential of the DC power supply. The transistor control circuit 513a may control the power semiconductor transistor 513b to be in an ON state, and thus the corresponding motor terminal 31 is connected with the negative potential of the DC power supply. When the transistor driving part 511a of the upper bridge arm controls the power semiconductor transistor 511b to be in the ON state, the transistor driving part 513a of the corresponding lower bridge arm controls the power semiconductor transistor 513b to be in an OFF state. Furthermore, when the transistor driving part 513a of the lower bridge arm controls the power semiconductor transistor 513b to be in the ON state, the transistor driving part 511a of the corresponding upper bridge arm controls the corresponding power semiconductor transistor 511b to be in an OFF state. When the switching elements of the upper and lower bridge arms switch on and off, a certain dead period is generally set, during which the switching elements of the upper and lower bridge arms are in the OFF state at the same time, so as to ensure that a current does not flow from the upper bridge arm to the lower bridge arm directly.

In this embodiment, a half-bridge circuit formed by combining a silicon carbide JEFT and a silicon carbide MOSFET, and a full-bridge circuit formed by a plurality of such half-bridge circuits are adopted. As compared with the silicon carbide MOSFET, the silicon carbide JFET has a better switching performance, a stronger short-circuit withstand capability, and a lower cost than the. Further, the silicon carbide JFET has a better reliability due to the absence of a gate oxide layer. On the other hand, short-circuit withstand capability of silicon carbide MOSFET is weaker. When a phase-to-phase short-circuit or a bridge-arm short-circuit occurs in the drive system, the silicon carbide JFET may bear most of the bus voltage. In this case, the silicon carbide JFET may be selected to turn off a short-circuit current. Because of its strong short-circuit withstand capability, the silicon carbide JFET may turn off the short-circuit current reliably and stably. The silicon carbide JEFT and silicon carbide MOSFET are connected in series at both ends of the DC power supply, and thus both share the bus voltage of the DC power supply. Since the short-circuit saturation current of the silicon carbide JEFT is designed or configured to be lower than the short-circuit saturation current of the silicon carbide MOSFET, when a phase-to-phase short-circuit or a short-circuit of the bridge arm occurs in the drive system, the short-circuit current on the bridge arm or the phase-to-phase short-circuit current is clamped by the lower short-circuit saturation current of the silicon carbide JEFT and does not reach the short-circuit saturation current of the silicon carbide MOSFET, and as a result, the silicon carbide MOSFET bear a smaller bus voltage. Because most of the bus voltage is borne by the silicon carbide JEFT, the part of the bus voltage borne by the silicon carbide MOSFET is very small. Therefore, the silicon carbide MOSFET may also be used to turn off the short-circuit current. Because the voltage across the silicon carbide MOSFET is very low, the actual short-circuit energy is also very small, the short-circuit current may be turned off reliably, as well. In an alternative embodiment, it is also possible to utilize both the silicon carbide JEFT and the silicon carbide MOSFET together to turn off the short circuit current.

Because a silicon carbide JFET is a normally-on device, when the drive system loses a control voltage, the power semiconductor transistors 511b, 521b, and 531b configured by the silicon carbide JFET are all in the ON state. At this time, the motor will enter an active short circuit (ASC) state. In the ASC state, all upper bridge arms or all lower bridge arms of bridge arms for three phases are turned on at the same time. There are many advantages for motor driving, especially for motor driving in electric vehicles, by the implementation of ASC. Such advantages includes: when the whole vehicle is out of control, a reverse torque may be generated by the implementation of ASC, to achieve safe parking; when a power battery fails, the motor and motor controller are isolated from the power battery by the implementation of ASC, to ensure high-voltage safety of the whole vehicle; when a switch device in a inverter circuit of the motor controller fails, a damage of an uncontrollable rectifier current to another device or the power battery may be avoided by the implementation of ASC. The existing control methods for making a drive system with both upper and lower bridges being configured by IGBTs or other normally-off transistors enter the ASC state when a fault occurs are complicated and difficult to implement reliably. As for the three-phase full-bridge drive system shown in FIG. 1, the combination of normally-on transistors (silicon carbide JEFTs) and normally-off transistors (silicon carbide MOSFETs) is adopted, so that the normally-on transistors in the three-phase full-bridge circuit may be automatically turned on at the same time in case of drive system failure or another failure, so that all terminals for three phases of the motor are short-circuited through the upper bridge arm, and the motor enters the ASC state without an additional complicated control method. Therefore, the embodiment described with reference to FIG. 1 has great practicability and benefits when applied to the field of electric vehicles.

Generally, upper and lower bridge arms of a half-bridge circuit of a drive system used for driving the motor adopt switching elements with the same characteristics and types, for example, the upper and lower bridge arms include IGBTs with the same characteristics. The upper and lower bridge arms in the embodiment described above with reference to FIG. 1 adopt different switching elements, the switching elements of the upper and lower bridge arms have different short-circuit withstand capability, and the switching elements with strong short-circuit withstand capability have a relatively lower short-circuit saturation current. The configuration of half-bridge circuit including hybrid devices may make full use of the performance of different switching elements, such as using the switching elements with strong short-circuit withstand capability to reliably turn off the short-circuit current, and avoiding the damage to switching elements/semiconductor transistors with weak short-circuit withstand capability, thus improving the reliability of the whole drive system. The half-bridge circuit including a silicon carbide JEFT and a silicon carbide MOSFET, and the three-phase full-bridge circuit configured by the above described half-bridge circuits has been described above with reference to FIG. 1, wherein short-circuit withstand capability of the silicon carbide JEFT is stronger than that of the silicon carbide MOSFET, and a short-circuit saturation current of silicon carbide JEFT is lower than that of the silicon carbide MOSFET, thus achieving the above technical effects.

It should be pointed out that, the combination of other switching elements that meet the above switching characteristics (different short-circuit withstand capability, and a switching element with stronger short-circuit withstand capability having a lower short-circuit saturation current) may also be adopted. IGBT is widely used in the industry because of its high reliability and mature product development. In one embodiment, a half-bridge circuit including a combination of an IGBT and a silicon carbide MOSFET and a three-phase full-bridge circuit configured by such half-bridge circuits may also be adopted, wherein a short-circuit withstand capability of the IGBT is stronger than that of the silicon carbide MOSFET, and a short-circuit saturation current of the IGBT is lower than that of the silicon carbide MOSFET. Similar to what was explained above about the combination of silicon carbide JEFT and silicon carbide MOSFET, this combination of the IGBT and silicon carbide MOSFET may also achieve a technical effect of turning off the short-circuit current reliably and avoiding damage to switching elements/semiconductor transistors with weak short-circuit withstand capability, and thus improving reliability of the whole drive system. In the case of the above combination, because a switching speed of the IGBT is relatively slow, crosstalk caused by IGBT switching process to the silicon carbide MOSFET will also be alleviated.

FIG. 2 shows a schematic diagram of a three-phase full-bridge drive system for motor driving according to another embodiment of the present disclosure. The embodiment is obtained by modifying the first embodiment by replacing JFETs with silicon carbide MOSFETs, that is, both upper and lower bridges being configured by the silicon carbide MOSFETs. For the silicon carbide MOSFETs, one silicon carbide MOSFET has stronger short-circuit withstand capability and a lower short-circuit saturation current than the other silicon carbide MOSFET. In one embodiment, silicon carbide MOSFETs which are exactly identical are adopted for the upper and lower bridge arms. In the case that the silicon carbide MOSFETs which are exactly identical are adopted for the upper and lower bridge arms, control is performed by driving parts (that are, transistor driving parts) connected with control terminals (that are, gates) of the silicon carbide MOSFETs of the upper and lower bridge arms, so as to improve short-circuit withstand capability of one silicon carbide MOSFET and reduce a short-circuit saturation current of the said silicon carbide MOSFET. In one embodiment, the short-circuit withstand capability of the silicon carbide MOSFET is improved by reducing a driving voltage of the silicon carbide MOSFET. In this case, when the driving voltage is reduced, the short-circuit saturation current will be reduced simultaneously. In another embodiment, it is also possible to increase the short-circuit saturation current of the switching element by connecting a plurality of transistors in parallel, and the said plurality of transistors in parallel is treated as a switching element in this case. In yet another embodiment, different types of silicon carbide MOSFETs are selected as transistors of the upper and lower bridge arms, respectively. In this case, one type of silicon carbide MOSFET is selected as a silicon carbide MOSFET with stronger short-circuit withstand capability and a lower short-circuit saturation current, while the other type of silicon carbide MOSFET is selected as a silicon carbide MOSFET with weaker short-circuit withstand capability and a higher short-circuit saturation current. Similar to what was explained above about the combination of silicon carbide JEFT and silicon carbide MOSFETs, the technical effect of reliably turning off the short-circuit current while avoiding damage to the MOSFET with a weaker short-circuit resistance, can also be achieved when both upper and lower bridge arms are equipped with silicon carbide MOSFETs.

A number of embodiments have been described above, in which half-bridge circuits including several different transistor combinations, three-phase full-bridge circuits and three-phase full-bridge driving systems formed by the half-bridge circuits are respectively described. In one embodiment, the half-bridge circuit is configured by the combination of a silicon carbide JEFT with stronger short-circuit withstand capability and a silicon carbide MOSFET with weaker short-circuit withstand capability. In another embodiment, the half-bridge circuit is configured by the combination of an IGBT with stronger short-circuit withstand capability and a silicon carbide MOSFET with weaker short-circuit withstand capability. In yet another embodiment, the half-bridge circuit is configured by the combination of a silicon carbide MOSFET and another silicon carbide MOSFET. In the half-bridge circuit, the silicon carbide MOSFET of the upper bridge arm and the silicon carbide MOSFET of the lower bridge arm are identical with each other, and the silicon carbide MOSFET of the upper bridge arm and the silicon carbide MOSFET of the lower bridge arm are controlled by their transistor driving parts to have different short-circuit withstand capability from each other, in which, the silicon carbide MOSFET with stronger short-circuit withstand capability is configured to have a lower short-circuit saturation current. Alternatively, the silicon carbide MOSFET of the upper bridge arm and the silicon carbide MOSFET of the lower bridge arm may be of different types, and may be designed to have different performance, in which, one type of silicon carbide MOSFET has stronger short-circuit withstand capability and a lower short-circuit saturation current, while the other type of silicon carbide MOSFET has weaker short-circuit withstand capability and a greater short-circuit saturation current. For the driving circuit or system described in the present disclosure, a disadvantage that the short-circuit withstand capability of the silicon carbide MOSFET is weak could be overcome to some extent.

It should be noted that, the transistor with stronger short-circuit withstand capability may be located in the lower bridge arm, while the transistor with weaker short-circuit withstand capability may be located in the upper bridge arm, and it is also possible that the transistor with stronger short-circuit withstand capability may be located in the upper bridge arm, while the transistor with weaker short-circuit withstand capability may be located in the lower bridge arm. In addition, although the present disclosure has been described above by referring to several combinations of transistors as mentioned above, this is provided only for the purpose of explanation and not for the purpose of limitation. In fact, the present disclosure may also include various other combinations of transistors, such as a combination of a gallium nitride HEMT and a silicon carbide JEFT, a combination of a type of gallium nitride HEMT with stronger short-circuit withstand capability and another type of gallium nitride HEMT with weaker short-circuit withstand capability, and a combination of a type of IGBT with stronger short-circuit withstand capability and another type of IGBT with weaker short-circuit withstand capability, and the like. In the case of adopting the combination of a gallium nitride HEMT and a silicon carbide JEFT, short-circuit withstand capability of the silicon carbide JEFT is stronger than that of the silicon nitride HEMT, and a short-circuit saturation current of the silicon carbide JEFT is lower than that of the silicon nitride HEMT, thus a disadvantage that the short-circuit withstand capability of the silicon nitride HEMT is weak could be overcome to some extent.

It also should be noted that the present disclosure describes various combinations of transistors. In the event of a bridge arm short-circuit or phase-to-phase short-circuit in the drive system, a transistor or switching element with greater short-circuit withstand capability can be utilized to turn off the short-circuit current. In one embodiment, transistors with weak short-circuit withstand capability can also be utilized to turn off the short-circuit current due to the fact that the transistors with weak short-circuit withstand capability bear a small bus voltage and have a small short-circuit energy, as described above with respect to the combinations of silicon carbide JEFT and silicon carbide MOSFET. In another embodiment, it is also possible to utilize both a transistor with stronger short-circuit withstand capability and a transistor with weaker short-circuit withstand capability to turn off the short-circuit current.

It should be understood that, although terms such as “first” and “second” are used in the present disclosure to describe various devices, elements, parts or stages, these devices, elements, parts or stages should not be limited by these terms. These terms are only used to distinguish one device, element, part or stage from another device, element, part or stage.

Although the present disclosure has been described in connection with some embodiments, the present disclosure is not intended to be limited to the specific forms and details set forth herein. Instead, the scope of the present disclosure is limited only by the appended claims and their equivalents. In addition, although individual features may be included in different claims, these features may be combined. The order of features in the claims does not imply any particular order in which the features must work. Furthermore, in the claims, the word “comprising” does not exclude other elements, and the terms “a” and “an” does not exclude a plurality.

1. A multi-phase full-bridge drive system for driving a motor, comprising:
a multi-phase full-bridge circuit, comprising at least three half-bridge circuits which are identical with each other, wherein each of the half-bridge circuits comprises a first transistor and a second transistor, wherein short-circuit withstand capability of the first transistor is stronger than short-circuit withstand capability of the second transistor and a short-circuit saturation current of the first transistor is lower than a short-circuit saturation current of the second transistor, and wherein each of the half-bridge circuits further comprises a first transistor driving part and a second transistor driving part, which are connected to a control terminal of the first transistor and a control terminal of the second transistor, respectively, to control the first transistor and the second transistor; and
a controller connected to the first transistor driving part and the second transistor driving part of each of the half-bridge circuits, respectively, to control the multi-phase full-bridge circuit to generate a target multi-phase driving voltage for driving the motor.

2. The multi-phase full-bridge drive system of claim 1, wherein the first transistor and the second transistor are a silicon carbide JFET and a silicon carbide MOSFET respectively; or the first transistor and the second transistor are an IGBT and a silicon carbide MOSFET respectively; or the first transistor and the second transistor are identical silicon carbide MOSFETs; or the first transistor and the second transistor are a first type of silicon carbide MOSFET and a second type of silicon carbide MOSFET respectively; or the first transistor and the second transistor are a silicon carbide JFET and a gallium nitride HEMT, respectively.

3. The multi-phase full-bridge drive system of claim 2, wherein in the case where the first transistor and the second transistor are identical silicon carbide MOSFETs, the first transistor and the second transistor are respectively configured by adjusting the first transistor driving part and the second transistor driving part of the half-bridge circuit, so that the short-circuit withstand capability of the first transistor is stronger than the short-circuit withstand capability of the second transistor, and the short-circuit saturation current of the first transistor is lower than the short-circuit saturation current of the second transistor.

4. The multi-phase full-bridge drive system of claim 1, wherein each of the half-bridge circuits further comprises a first diode connected with the first transistor in anti-parallel and/or a second diode connected with the second transistor in anti-parallel.

5. The multi-phase full-bridge drive system of claim 4, wherein each of the first diode and the second diode is selected from a group comprising a silicon carbide diode with a Schottky structure and a fast recovery diode.

6. The multi-phase full-bridge drive system of claim 1, wherein the first transistor and the second transistor are a normally-on device and a normally-off device, respectively, and in response to the multi-phase full-bridge drive system losing control, the first transistors of all the half-bridge circuits are turned on simultaneously to put the motor into an active short-circuit state.

7. The multi-phase full-bridge drive system of claim 6, wherein the first transistor and the second transistor are a silicon carbide JFET and a silicon carbide MOSFET, respectively.

8. A half-bridge circuit for driving a motor, comprising:
a first transistor and a second transistor, wherein short-circuit withstand capability of the first transistor is stronger than short-circuit withstand capability of the second transistor and a short-circuit saturation current of the first transistor is lower than a short-circuit saturation current of the second transistor; and
a first transistor driving part and a second transistor driving part connected to a control terminal of the first transistor and a control terminal of the second transistor, respectively, to control the first transistor and the second transistor.

9. The half-bridge circuit of claim 8, wherein the first transistor and the second transistor are a silicon carbide JFET and a silicon carbide MOSFET, respectively; or the first transistor and the second transistor are an IGBT and a silicon carbide MOSFET, respectively; or the first transistor and the second transistor are identical silicon carbide MOSFETs; or the first transistor and the second transistor are a first type of silicon carbide MOSFET and a second type of silicon carbide MOSFET, respectively; or the first transistor and the second transistor are a silicon carbide JFET and a gallium nitride HEMT, respectively.

10. The half-bridge circuit of claim 9, wherein in the case where the first transistor and the second transistor are identical silicon carbide MOSFETs, the first transistor and the second transistor are respectively configured by adjusting the first transistor driving part and the second transistor driving part, so that the short-circuit withstand capability of the first transistor is stronger than the short-circuit withstand capability of the second transistor, and the short-circuit saturation current of the first transistor is lower than the short-circuit saturation current of the second transistor.

11. The half-bridge circuit of claim 8, wherein the half-bridge circuit further comprises a first diode connected with the first transistor in anti-parallel and/or a second diode connected with the second transistor in anti-parallel.

12. The half-bridge circuit of claim 11, wherein each of the first diode and the second diode is selected from a group comprising a silicon carbide diode with a Schottky structure and a fast recovery diode.

13. A three-phase full-bridge drive system for driving a motor, comprising a three-phase full-bridge circuit configured by three half-bridge circuits, wherein each of the three half bridge circuits comprising:
a first transistor and a second transistor, wherein short-circuit withstand capability of the first transistor is stronger than short-circuit withstand capability of the second transistor and a short-circuit saturation current of the first transistor is lower than a short-circuit saturation current of the second transistor; and
a first transistor driving part and a second transistor driving part connected to a control terminal of the first transistor and a control terminal of the second transistor, respectively, to control the first transistor and the second transistor.

14. The three-phase full-bridge drive system of claim 13, wherein the first transistor and the second transistor are a silicon carbide JFET and a silicon carbide MOSFET, respectively; or the first transistor and the second transistor are an IGBT and a silicon carbide MOSFET, respectively; or the first transistor and the second transistor are identical silicon carbide MOSFETs; or the first transistor and the second transistor are a first type of silicon carbide MOSFET and a second type of silicon carbide MOSFET, respectively; or the first transistor and the second transistor are a silicon carbide JFET and a gallium nitride HEMT, respectively.

15. The three-phase full-bridge drive system of claim 14, wherein in the case where the first transistor and the second transistor are identical silicon carbide MOSFETs, the first transistor and the second transistor are respectively configured by adjusting the first transistor driving part and the second transistor driving part, so that the short-circuit withstand capability of the first transistor is stronger than the short-circuit withstand capability of the second transistor, and the short-circuit saturation current of the first transistor is lower than the short-circuit saturation current of the second transistor.

16. The three-phase full-bridge drive system of claim 13, wherein the half-bridge circuit further comprises a first diode connected with the first transistor in anti-parallel and/or a second diode connected with the second transistor in anti-parallel.

17. The three-phase full-bridge drive system of claim 16, wherein each of the first diode and the second diode is selected from a group comprising a silicon carbide diode with a Schottky structure and a fast recovery diode.
